(19) United States
(12) Patent Application Publication
(10) Pub. No.: US 2011/0032254 A1
(43) Pub. Date: Feb. 10, 2011

(54) SHEET METAL MODEL CREATION DEVICE AND SHEET METAL MODEL CREATION METHOD

(75) Inventors: Yukio KATANO, Kanagawa (JP); Satoshi SAKAI, Newport Beach, CA (US)

Correspondence Address: GREENBLUM & BERNSTEIN, P.L.C., 1950 ROLAND CLARKE PLACE, RESTON, VA, 20191, US

(73) Assignee: AMADA COMPANY, LIMITED, Kanagawa (JP)

(21) Appl. No.: 12/538,369

(22) Filed: Aug. 10, 2009

(51) Int. Cl. G06T 17/00

(52) U.S. Cl. 345/420

(57) ABSTRACT

A sheet metal model creation device (1) for creating a sheet metal model while displaying a three-view drawing includes: a three-view drawing reader (13) configured to read three-view drawing information and display the three-view drawing on a screen; a three-view drawing display controller (15); a three-dimensional face creator (17) configured to create a three-dimensional face associated with an element of the three-view drawing selected on the screen in response to an operation of a mouse; and a model display controller (19) configured to combine the three-dimensional face with the sheet metal model and display the model. Here, the operation of the mouse is movement of a mouse (7), and selection of the element of the three-view drawing on the screen is selection of an element within a region that is based on a position of a mouse pointer associated with the movement of the mouse (7).

### BACKGROUND OF THE INVENTION

1. Field of the Invention

The present invention relates to a sheet metal model creation device and a sheet metal model creation method. More specifically, the present invention relates to a sheet metal model creation device and a sheet metal model creation method for creating a sheet metal solid model while displaying a model corresponding to a movement position of a mouse on a three-view drawing of a sheet metal product.

2. Description of the Related Art

While shape definition of a sheet metal product by use of a sheet metal three-view drawing is widely performed, it is generally difficult to accurately read the sheet metal three-view drawing itself. Thus, there is adopted a method of automatically creating a sheet metal model by collectively reading three-view drawing information. However, such a method is not satisfactory.

Meanwhile, in the case of creating a sheet metal model by use of an interactive mode, a projected face (a flange face and a sheet thickness face) associated with the same plane of a three-dimensional drawing is specified from different projected faces (a plan view, a front view, a side view and the like) according to the third angle projection method. Thus, a flange of the three-dimensional drawing is defined from a relationship between the projected faces and a size and a shape of the flange face, even in the sheet metal three-view drawing. Furthermore, the face is specified by clicking on multiple line segments, and the like.

Other Related Art than described above are disclosed in a Patent Brochure, Japanese Patent Application Laid-Open No. 2004-234164.

Such conventional sheet metal model creation devices and method have the following problems.

In the case of a solidification mechanism by automatic processing, an object is a limited sheet metal three-view drawing. Therefore, such a mechanism cannot handle a complex shape. Moreover, there is a problem that, when solidification cannot be executed, it is difficult to determine in many cases whether the shape is too complex for the solidification or the sheet metal three-view drawing itself is wrong.

Moreover, many automatic solidification systems for the three-view drawing aimed at the sheet metal shape cannot handle a three-view drawing in which not all information required for solidification is written. In this case, processing has to be performed in an uncertain situation, which brings about the following problem. Specifically, although solidification is possible for a simple drawing because of its small number of combinations, only incomplete solidification is possible for a practical three-view drawing.

Furthermore, in the case of creating a sheet metal model by use of an interactive mode, while shape definition of a sheet metal product by use of a sheet metal three-view drawing is widely performed, it is generally difficult to accurately read the complex sheet metal three-view drawing itself. Thus, there is a problem that the reading takes time, and the like. Moreover, a skill to accurately read the three-view drawing is required.

### SUMMARY OF THE INVENTION

The present invention has been achieved with such points in mind.

It therefore is an object of the present invention to provide a sheet metal model creation device and a sheet metal model creation method which making it possible to get a three-dimensional shape by an easy operation and which enabling an operator to grasp the overview of the three-dimensional shape of the product by performing an operation of tracing all projected faces with a mouse.

To achieve the object, according to a first aspect of the present invention, there is provided a sheet metal model creation device for creating a sheet metal model while displaying a three-view drawing, the device including: a unit configured to display a three-view drawing on a screen based on three-view drawing information read; a unit configured to create a three-dimensional face associated with an element of the three-view drawing, the element being selected on the screen in response to an operation of a pointing device; and a unit configured to display the three-dimensional face as a part of the sheet metal model.

A second aspect of the present invention is the sheet metal model creation device according to the first aspect, in which the operation of the pointing device is movement of a mouse, and the element of the three-view drawing, the element being selected on the screen, is an element retrieved within a region that is based on a position of a mouse pointer. A third aspect of the present invention is the sheet metal model creation device according to one of the first and second aspects, the device further including: a unit configured to set the element of the three-view drawing as a selected element when the element is selected on the screen.

A fourth aspect of the present invention is the sheet metal model creation device according to any one of the first to third aspects, in which, when there are multiple three-dimensional faces associated with the selected element of the three-view drawing, the multiple three-dimensional faces are sequentially displayed as candidates so as to be selectable.

A fifth aspect of the present invention is the sheet metal model creation device according to any one of the first to fourth aspects, in which, the element retrieved is a determined slot candidate; and the determined slot candidate is emphasizedly displayed.

A sixth aspect of the present invention is the sheet metal model creation device according to any one of the first to fifth aspects, in which, the element retrieved is a determined flange face candidate; and the determined flange face candidate is emphasizedly displayed.

A seventh aspect of the present invention is a sheet metal model creation method for creating a sheet metal model while displaying a three-view drawing, the method including the steps of displaying a three-view drawing on a screen based on three-view drawing information read; creating a three-dimensional face associated with an element of the three-view drawing, the element being selected on the screen in response to an operation of a pointing device; and displaying the three-dimensional face as a part of the sheet metal model.

The invention of the present application makes it possible to get a three-dimensional shape by an easy operation. Moreover, the invention enables an operator to grasp the overview of the three-dimensional shape of the product by performing an operation of tracing all projected faces with a mouse, to sequentially make selections and to proceed with his/her operation by making a determination if there are multiple candidates (preferential order is automatically selected).

Moreover, as to the determined face, in addition to creating the three-dimensional face, the face is locked so as not to be selected by changing a display color and the like on the projected face. Thus, the later the more info nation from the previously determined face is used. As a result, the candidates to be selected by the operator are reduced. The three-dimensional face created every time is stored, including a positional relationship. Eventually, when there is no more element not to be solidified on the projected face, the entire target three-view drawing can be solidified.

Thus, the operating side can solidify the sheet metal three-view drawing by an easy operation without having to take into consideration complicated portions about the solidification of the sheet metal three-view drawing. Thus, there is an effect that conversion from the sheet metal three-view drawing information to information to be put into a CAM and the like can be accurately performed in a short time.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIG. 1 is a explanatory diagram for explaining model editing processing operation which is a part of the sheet metal model creation method according to the present invention;

FIG. 2 is a schematic diagram for explaining a schematic configuration of a sheet metal model creation device according to the present invention;

FIG. 3 is a flowchart showing operations of the sheet metal model creation device;

FIG. 4 is a flowchart showing operations of processing of editing elements that make up a sheet metal model;

FIG. 5A and FIG. 5B are explanatory diagrams for explaining model editing processing;

FIG. 6A and FIG. 6B are explanatory diagrams for explaining the model editing processing;

FIG. 7 is an explanatory diagram for explaining face definition;

FIG. 8 is an explanatory diagram for explaining loop definition;

FIG. 9 is an explanatory diagram for explaining slot definition; and

FIG. 10A and FIG. 10B are explanatory diagrams for explaining a tolerance.

### DESCRIPTION OF THE PREFERRED EMBODIMENTS

There will be detailed below the preferred embodiments of the present invention with reference to the accompanying drawings. Like members are designated by like reference characters.

Here, a three-view drawing in this embodiments will be defined. The three-view drawing means a drawing in which faces projected from a direction determined as the front and from top, bottom, left and right are displayed on one plane. The three-view drawing normally includes three projected faces, a front view, a plan view and a side view. Although the normal three-view drawing is described as an example also in this example, a target drawing is not necessarily the three-view drawing but may be a two-view to six-view drawing.

Moreover, the sheet metal product in this example will be defined. A three-dimensional figure of a target sheet metal product includes flat plates having a fixed thickness and a connection part connecting the flat plates. As to a three-dimensional figure to navigate the three-view drawing in this example, a shape of the connection part connecting the flat plates is not accurately drawn on the three-view drawing in many cases. Thus, this portion is omitted and the drawing is formed of the flat plates with the fixed thickness. In actual use, the three-dimensional figure can be collectively created by defining connection information between the flat plates. The connection part may be right-angled or may involve R, and a length thereof is adjusted by taking into consideration a tolerance (to be described later).

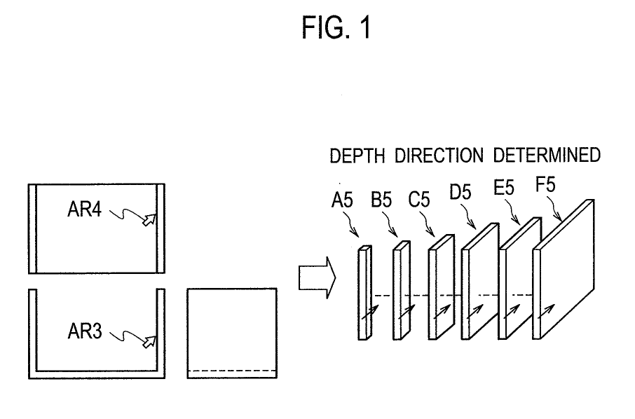

Referring now to FIG. 1, a sheet metal model creation method according to the present invention will be described, specifically determining depth of a flange portion of a sheet metal product.

First of all, assuming a flange to be solidified, two or more related ranges on a three-view drawing are specified to create a three-dimensional face, as shown in FIG. 1. Specifically, the flange can be determined by pointing out a position of a cursor AR3 and a position of a cursor AR4, which are displayed by a mouse. Since the cursor AR3 cannot specify a depth of the flange, a depth E5 is determined from among depths A5 to F5 by selecting the cursor AR4.

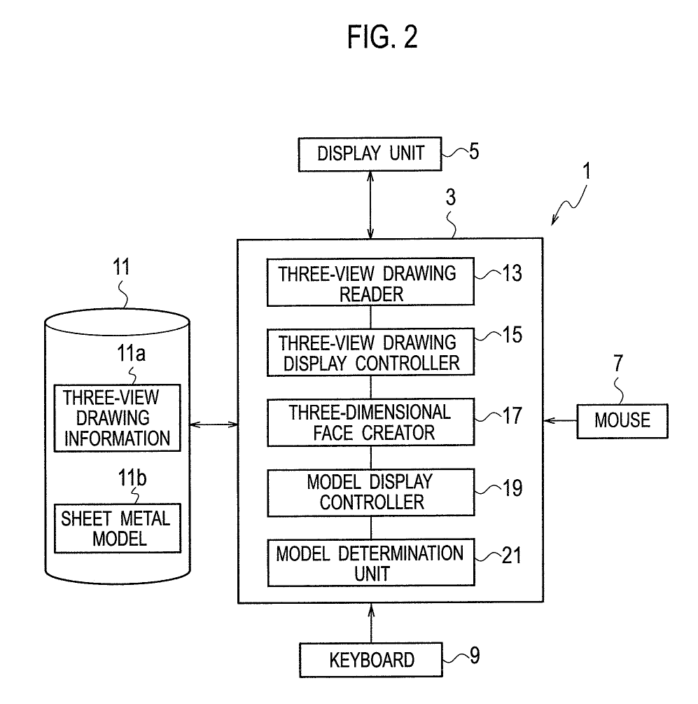

Next, FIG. 2 schematically shows a sheet metal model creation device 1. The sheet metal model creation device 1 includes a controller 3 (formed of a computer), a display unit 5, a mouse 7, a keyboard 9 and a memory 11. The memory 11 has a three-view drawing information memory region 11a and a sheet metal model memory region 11b. The controller 3 includes a three-view drawing reader 13, a three-view drawing display controller 15, a three-dimensional face creator 17, a model display controller 19 and a model determination unit 21.

The controller 3 performs overall control for creating a sheet metal model from the three-view drawing information.

The display unit 5 is a display processor (a CRT, an LCD or the like) configured to display a three-view drawing and to three-dimensionally display a sheet metal model to be created.

The mouse 7 (one aspect of a pointing device) is a kind of an input device among computer peripheral devices, and is used mainly to operate a pointer or an icon displayed on a screen. The mouse 7 is one of man-machine interfaces as a contact point between the computer and a person. Moreover, the mouse 7 is a device mainly for instructing and inputting information, such as a position, a state and a direction, with an arrow called a cursor or a cross-shaped mark in a GUI environment providing an intuitive input operation for an image displayed on a screen of a display classified as a display device among output devices of the computer.

The keyboard 9 is connected to the computer (the controller 3 and the like), and is an input device for inputting characters, numerical values and the like based on an operation of pressing a button and the like by an operator.

The three-view drawing information memory region 11a that is a part of a storage area of the memory 11 is a memory region for storing the three-view drawing information that is three-view drawing data on a sheet metal product. For example, graphic information on a front view, a plan view and a side view is stored in the memory region 11a.

The sheet metal model memory region 11b is a part of the storage area of the memory 11. The sheet metal model memory region 11b sequentially stores sheet metal models to be created from three-view drawings displayed on the display unit 5 by an operation performed by the operator.

The three-view drawing reader 13 performs processing of reading the three-view drawing information from the three-view drawing information memory region 11a. The read three-view drawing information is temporarily stored.

The three-view drawing display controller 15 performs control of displaying a three-view drawing on the display unit 5 based on the three-view drawing information read by the three-view drawing reader 13. For the three-view drawing displayed based on the read three-view drawing information, the three-dimensional face creator 17 creates a three-dimensional face associated with an element of the three-view drawing selected on a screen in response to an operation of the mouse 7. Moreover, the three-dimensional face creator 17 performs data editing for combining the three-dimensional face with a sheet metal model and displaying the model. To be more specific, as to selection of the element of the three-view drawing on the screen, an element within a region that is based on a position of a cursor associated with movement of the mouse (for example, a circular region of 5 mm or smaller in diameter with the cursor position as its center) is retrieved and the retrieved element is selected.

The model display controller 19 combines the three-dimensional face created by the three-dimensional face creator 17 with the sheet metal model that is being created and displays the model on the display unit 5.

The model determination unit 21 sets an element of the three-view drawing as a selected element when the element is selected on the screen. Moreover, when there is more than one three-dimensional face associated with the selected element of the three-view drawing, candidates are sequentially displayed so as to be selectable.

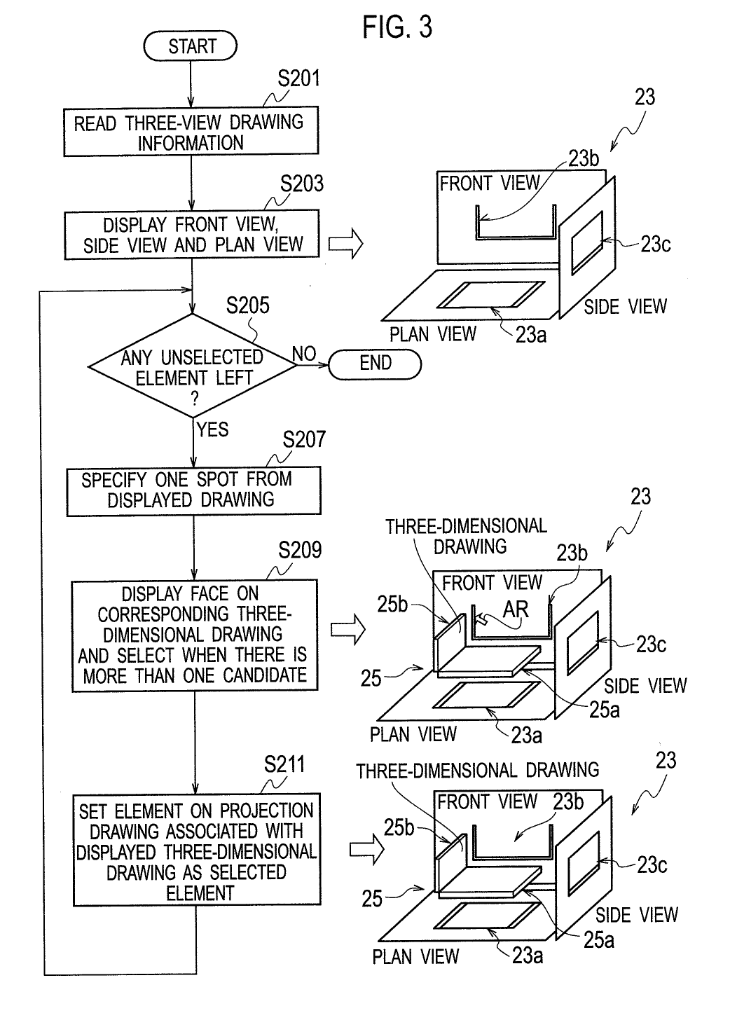

With reference to FIG. 3, operations of the sheet metal model creation device 1 will be described.

First, in Step S201, the three-view drawing reader 13 reads three-view drawing information stored in the three-view drawing information memory region 11a of the memory 11.

In Step S203, the three-view drawing display controller 15 displays a three-view drawing on the display unit 5 based on the read three-view drawing information by separating the drawing into a front view, a side view and a plan view. In this event, a plan view 23a, a front view 23b and a side view 23c are displayed in a display region 23 of a coordinate system defined in a three-dimensional space (X-Y-Z axis space) as shown in FIG. 3.

In Step S205, the model determination unit 21 determines whether or not there is any unselected element left among the plan view 23a, the front view 23b and the side view 23c in the display region 23. When it is determined that there is the unselected element left, the processing moves to Step S207. On the other hand, when it is determined that there is no unselected element left, the processing is terminated.

In Step S207, one spot is specified from the displayed drawing (the plan view, the front view and the side view) by operating the mouse 7. As to selection of the element of the three-view drawing on the screen of the display unit 5, an element within a region that is based on a position of a cursor associated with movement of the mouse 7 (for example, a circular region of 5 mm or smaller in diameter with the cursor as its center) is retrieved and the retrieved element is selected. Thus, the element on the three-view drawing can be automatically selected by the operation of only moving the mouse 7.

In Step S209, the three-dimensional face creator 17 creates a three-dimensional face associated with the element of the three-view drawing selected on the screen in response to the operation of the mouse 7. Thereafter, the model display controller 19 combines the corresponding three-dimensional face with an existing sheet metal model and displays the model.

As shown in FIG. 3, when a cursor AR moved along with the movement of the mouse 7 is brought closer to a part of the front view 23b in the three-view drawing with the mouse 7, the three-dimensional face creator 17 creates a three-dimensional face 25b in a corresponding sheet metal model 25 (three-dimensional face 25a). Thereafter, the model display controller 19 combines the created three-dimensional face 25b with the existing three-dimensional face 25a of the sheet metal model 25 and displays the model.

Note that, when there are multiple candidates of the three-dimensional face, a three-dimensional face to be the candidate may be sequentially displayed by selecting “NEXT” in a menu displayed on the screen. Then, when a corresponding three-dimensional face is displayed, the three-dimensional face may be selected by selecting “SELECT” in the menu or only by operating the mouse. Thus, the three-dimensional face is determined and is not deleted by movement of the mouse 7.

As described above, it is possible to get a three-dimensional shape by an easy operation. Moreover, the operator can grasp the overview of the three-dimensional shape of the product by performing an operation of tracing all the projected faces with the mouse, make selections from a less incomplete portion and proceed with his/her operation by making a determination if there are multiple candidates (preferential order is automatically selected).

In Step S211, the model determination unit 21 sets an element on a projection drawing associated with the displayed three-dimensional drawing as the selected element. Specifically, the element on the projection drawing associated with the selected flange is prevented from being selected again by changing a color and the like. Thereafter, the processing returns to Step S205.

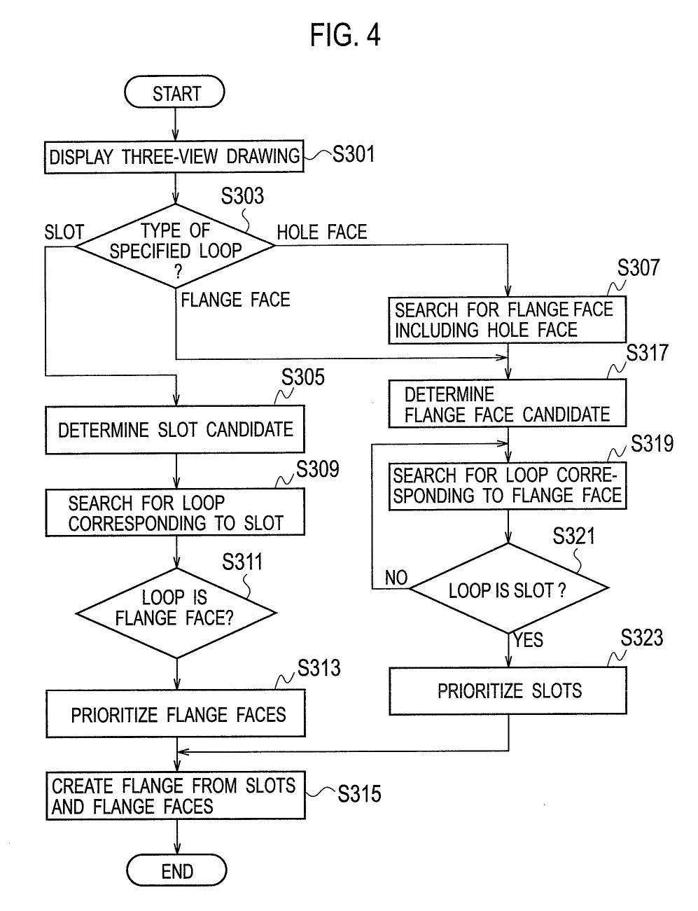

With reference to FIGS. 4 to 10B, the embodiment of the present invention will be described.

First, in Step S301, the three-view drawing display controller 15 displays a three-view drawing. Here, for the purpose of making it easier to visually recognize a positional relationship between faces of the three-view drawing displayed on the display unit 5, the three-view drawing is displayed by faces corresponding to the faces of a cube covering the three-dimensional shape (see FIGS. 3, 5A, and 6A).

In Step S303, the three-dimensional face creator 17 determines a type of a loop extracted from the element specified with the mouse 7. Specifically, the three-dimensional face creator 17 determines whether the loop including the specified element is a slot or a flange loop or a hole loop. In the case of the slot, the processing moves to Step S305. In the case of the flange loop, the processing moves to Step S317. Moreover, in the case of the hole loop, the processing moves to Step S317 after extracting the flange loop including the hole loop.

For extraction of each loop, each projected face of a corresponding three-view drawing including a mouse pointer (cursor) of the mouse 7 is first determined. Thereafter, a loop including a point indicated by the mouse pointer on a corresponding projection drawing is extracted. Note that the number of loops to be extracted is not always 1.

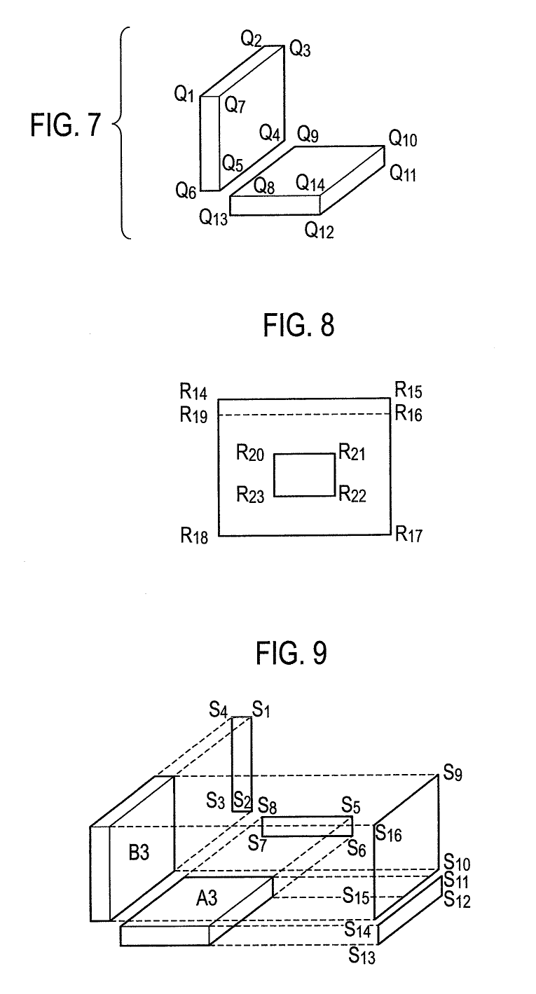

Here, with reference to FIGS. 7 to 9, kinds of faces, loops and slots in this example will be defined as described below.

As shown in FIG. 7, a sheet metal product is formed of planes having a fixed thickness. Moreover, the plane itself is called a flange.

Specifically, the planes include two kinds of faces, a face itself called a flange face and a face of a thickness portion called a sheet thickness face. In the example of the sheet metal product, [Q₃-Q₄-Q₅-Q₇] and [Q₈-Q₉-Q₁₀-Q₁₄] are the flange faces and [Q₁-Q₂-Q₃-Q₇], [Q₁-Q₇-Q₅-Q₆] and [Q₁₀-Q₁₁-Q₁₂-Q₁₄] are the sheet thickness faces. With reference to FIG. 8, a closed path within each projection drawing on the three-view drawing is called a loop (there are only different vertexes within the loop). Many of the loops form the flange face, the sheet thickness face and a hole face. There is also a loop that does not actually exist in a three-dimensional figure of a projection source. [R₁₄-R₁₅-R₁₆-R₁₉], [R₁₆-R₁₇-R₁₈-R₁₉] and [R₁₄-R₁₅-R₁₇-R₁₈] are the loops. The loop as the hole face is [R₂₀-R₂₁-R₂₂-R₂₃].

With reference to FIG. 9, the sheet thickness face on the three-view drawing is called a slot. A flange having a flange face corresponding to the slot (sheet thickness face) is combined. Loops [S₁-S₂-S₃-S₄] and [S₅-S₆-S₇-S₈] on the projected faces are slots (sheet thickness faces), which become slots of a flange [B3] and a flange [A3], respectively. Moreover, a loop [S₁₁-S₁₂-S₁₃-S₁₄] on the front view is a slot, which becomes a slot of the flange [A3]. Even the slots of the same flange appear on the different projected faces. Moreover, [S₉-S₁₀-S₁₅-S₁₆] is not a slot.

Furthermore, description will be given of a method for determining a sheet thickness when no sheet thickness is specified. By utilizing the fixed thickness of the sheet metal product, a portion having a shortest length between parallel lines among those that meet the following two conditions: “loop straight portions parallel to each other with the same length are extracted” (Condition 1) from the loop on the projected face; and “at least a line on one side among the parallel lines is a peripheral portion” is set to be the sheet thickness.

Next, the types of the loops and a determination method thereof will be described. The faces represented by the loops are classified into the three types, the slot (sheet thickness face), the flange face and the hole face. A relationship between the loop and the face cannot be determined only by the projected face including the loop. Therefore, the relationship is determined based on a relationship with a corresponding loop on another related projected face. A relationship between the loop and the projected face, and the conditions of the fixed thickness unique to sheet metal are utilized.

When the length between the parallel lines is the same as the sheet thickness and the loop has a rectangular shape, the loop is determined to be the “slot”. Moreover, one other than the slot face and having a slot on a corresponding projected face is set to be the flange face. Here, the slot on the corresponding projected face means a case where there is a loop to be a slot by a combination of vertexes on the corresponding projected face (the projected faces do not always have to be remaining two faces).

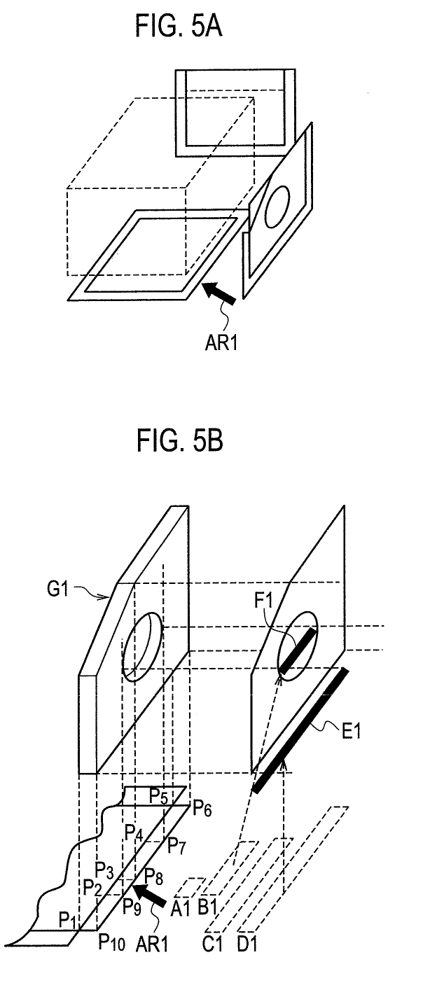

In Step S305, the three-dimensional face creator 17 determines a slot candidate. The determined slot candidate is emphasizedly displayed. With reference to FIGS. 5A and 5B, first, a loop including a specific element is set as a first slot candidate. [P₂-P₉-P₈-P₃] is set as a first slot [Candidate A1]. Note that examples of the candidate include [P₂-P₉-P₇-P₄] as [Candidate B1], [P₁-P₁₀-P₇-P₄] as [Candidate C1], [P₁-P₁₀-P₆-P₅] as [Candidate D1] and the like.

In Step S309, the three-dimensional face creator 17 searches for a loop corresponding to the slot (in this example, determination is made based on that lengths match). Specifically, a loop having a cross-section that matches the slot (with a tolerance) is searched for. [Candidate F1] is searched for as a portion corresponding to [Candidate B1] and [Candidate E1] is searched for as a portion corresponding to [Candidate D1], and those candidates are associated with each other. Meanwhile, it is determined that there are no loops corresponding to [Candidate A1] and [Candidate C1].

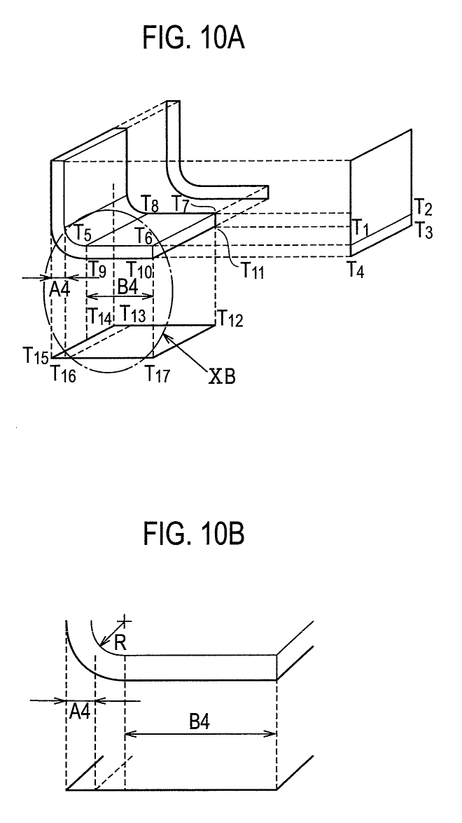

Here, with reference to FIGS. 10A and 10B, the tolerance (tolerable range) will be described. In many cases, size equivalence determination for searching for a flange corresponding to the slot is not always accurately written in a drawing drawn on the assumption that the operator reads the drawing. Thus, it is required to take into consideration the tolerance (tolerable range). As the tolerance (tolerable range), graphic accuracy, a radius of a connection part and a sheet thickness are taken into consideration.

Since a connection part of a flange is drawn as an arc with a radius R, in search for a flange for a slot [T₁-T₂-T₃-T₄], flange faces [T₁₂-T₁₃-T₁₆-T₁₇], [T₁₄-T₁₂-T₁₇-T₁₅] and [T₁₄-T₁₃-T₁₆-T₁₅] in a corresponding relationship therewith are searched for. However, a flange face equivalent to a correct flange face [T₅-T₆-T₇-T₈-T₉-T₁₀-T₁₁] cannot be searched for. A length of a correct flange is B4 (B). Between [T₁₆-T₁₇], a value of B4+R (B+R) is set. Such a relationship can be found out by taking into consideration the radius R of the connection part in the case of searching for the flange face corresponding to the slot.

In Step S311, the three-dimensional face creator 17 determines whether or not a loop is a flange face if the loop is not a slot or a hole. When the loop is the flange face, the processing moves to Step S313. On the other hand, when the loop is not the flange face, the processing returns to Step S309. Thus, the flange is associated with the slot.

In Step S313, when there are multiple flange faces, the three-dimensional face creator 17 prioritizes the flange faces.

In Step S315, the three-dimensional face creator 17 uses the slots and the flange faces to create a flange. Thereafter, the processing is terminated.

Meanwhile, in Step S307, the three-dimensional face creator 17 searches for a flange face including a hole face. Specifically, since the hole face is a closed loop and the flange face is also a closed loop, a closed loop outside the hole face can be set as the flange face including the hole face.

In Step S317, the three-dimensional face creator 17 determines a flange face candidate. The determined flange face candidate is emphasizedly displayed.

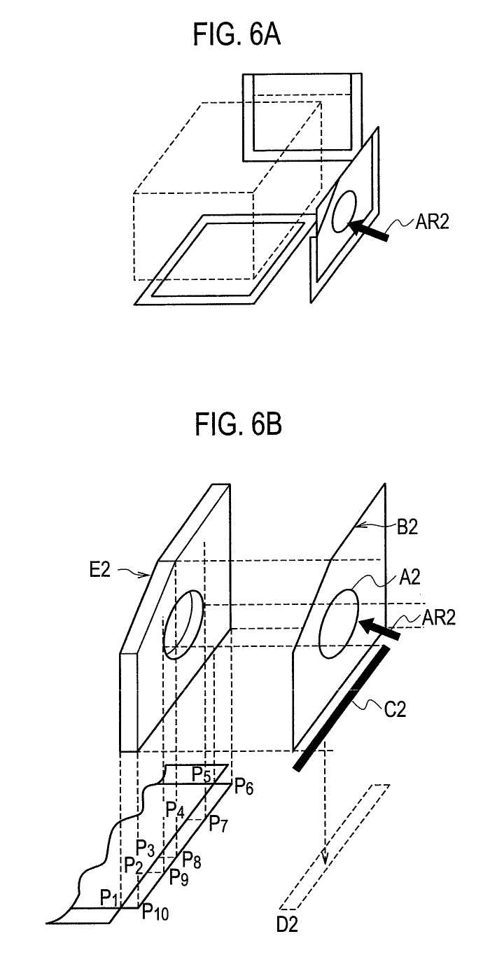

In Step S319, the three-dimensional face creator 17 searches for a loop corresponding to the flange face. With reference to FIGS. 6A and 6B, there is [P₁-P₁₀-P₆-P₅] as [Candidate D2]. In Step S321, the three-dimensional face creator 17 determines whether or not the loop is a slot. When it is determined that the loop is the slot, the processing moves to Step S323. On the other hand, when it is determined that the loop is not the slot, the processing returns to Step S319.

In Step S323, the three-dimensional face creator 17 prioritizes the slots. Thereafter, the processing moves to Step S315.

In Step S315, the three-dimensional face creator 17 uses the slots and the flange faces to create a flange. Thereafter, the processing is terminated.

Although the invention has been described above by reference to certain embodiments of the invention, the invention is not limited to the embodiments described above. Modifications and variations of the embodiments descried above will occur to those skilled in the art, in light of the above teachings. The scope of the invention is defined with reference to the following claims.

What is claimed is:

1. A sheet metal model creation device for creating a sheet metal model while displaying a three-view drawing, comprising:
a unit configured to display a three-view drawing on a screen based on three-view drawing information which is read;
a unit configured to create a three-dimensional face associated with an element of the three-view drawing, the element being selected on the screen in response to an operation of a pointing device; and
a unit configured to display the three-dimensional face as a part of the sheet metal model.

2. The sheet metal model creation device according to claim 1, wherein
the operation of the pointing device is movement of a mouse, and
the element of the three-view drawing, which is selected on the screen, is an element retrieved within a region that is based on a position of a mouse pointer.

3. The sheet metal model creation device according to claim 1, further comprising:
a unit configured to set the element of the three-view drawing as a selected element when the element is selected on the screen.

4. The sheet metal model creation device according to claim 2, further comprising:
a unit configured to set the element of the three-view drawing as a selected element when the element is selected on the screen.

5. The sheet metal model creation device according to claim 1, wherein
when there are a plurality of three-dimensional faces associated with the selected element of the three-view drawing, the plurality of three-dimensional faces are sequentially displayed as candidates so as to be selectable.

6. The sheet metal model creation device according to claim 2, wherein
when there are a plurality of three-dimensional faces associated with the selected element of the three-view drawing, the plurality of three-dimensional faces are sequentially displayed as candidates so as to be selectable.

7. The sheet metal model creation device according to claim 3, wherein
when there are a plurality of three-dimensional faces associated with the selected element of the three-view drawing, the plurality of three-dimensional faces are sequentially displayed as candidates so as to be selectable.

8. The sheet metal model creation device according to claim 4, wherein
when there are a plurality of three-dimensional faces associated with the selected element of the three-view drawing, the plurality of three-dimensional faces are sequentially displayed as candidates so as to be selectable.

9. The sheet metal model creation device according to claim 2, wherein
the element retrieved is a determined slot candidate; and
the determined slot candidate is emphasizedly displayed.

10. The sheet metal model creation device according to claim 2, wherein
the element retrieved is a determined flange face candidate; and
the determined flange face candidate is emphasizedly displayed.

11. A sheet metal model creation method for creating a sheet metal model while displaying a three-view drawing, comprising the steps of:
displaying a three-view drawing on a screen based on three-view drawing information which is read;
creating a three-dimensional face associated with an element of the three-view drawing, the element being selected on the screen in response to an operation of a pointing device; and
displaying the three-dimensional face as a part of the sheet metal model.
